(19) United States
(12) Patent Application Publication
(10) Pub. No.: US 2014/0028052 A1
(43) Pub. Date: Jan. 30, 2014

(54) ENERGY ABSORBING CARTRIDGE FOR VEHICLE SUPPORT PILLAR

(71) Applicants: Christian Ibanez Diaz, Toluca (MX); Jeffrey G. Combs, Imlay City, MI (US); Matthew C. Vitale, Ray, MI (US); Darlene R. Reimann, Troy, MI (US)

(72) Inventors: Christian Ibanez Diaz, Toluca (MX); Jeffrey G. Combs, Imlay City, MI (US); Matthew C. Vitale, Ray, MI (US); Darlene R. Reimann, Troy, MI (US)

(73) Assignee: GM GLOBAL TECHNOLOGY OPERATIONS LLC, Detroit, MI (US)

(21) Appl. No.: 13/557,752

(22) Filed: Jul. 25, 2012

(51) Int. Cl. B60R 21/04; B62D 25/04

(52) U.S. Cl. 296/187.05

(57) ABSTRACT

An energy absorbing cartridge for covering a substantially rigid vehicle support pillar is provided. The energy absorbing cartridge has an accordion-shaped portion including a plurality of spaced load distribution walls for distributing and transferring an applied impact force, a plurality of spaced side walls for absorbing the applied impact force, and a plurality of spaced stabilization walls for stabilizing the spaced side walls upon application of the applied impact force. The spaced side walls are substantially perpendicular to the spaced load distribution walls, and the spaced stabilization walls are substantially parallel to the spaced load distribution walls. The plurality of spaced side walls connect, respectively, the plurality of spaced load distribution walls and the plurality of spaced stabilization walls to form the accordion-shaped portion of the energy absorbing cartridge.

### TECHNICAL FIELD

This invention relates to an energy absorbing cartridge for covering a substantially rigid vehicle support pillar.

### BACKGROUND

Automotive vehicles are designed to provide impact force absorption in a vehicle passenger compartment. Such impact force absorption may include an energy absorbing cartridge positioned between a vehicle structural support member such as a “B” pillar of a vehicle frame and an interior trim module for the “B” pillar. Some energy absorbing cartridges use ribs spaced along the edge of the cartridge which may add cost, weight or complexity of design. Other energy absorbing cartridges use a “dog house” alternative which may add complexity, height and/or thickness issues. Still other designs include additional foam or plastic pieces which increase complexity to provide energy absorption.

### SUMMARY

An energy absorbing cartridge for covering a substantially rigid vehicle support pillar is provided. The energy absorbing cartridge has an accordion-shaped portion with a plurality of spaced load distribution walls for distributing and transferring an applied impact force, a plurality of spaced side walls for absorbing the applied impact force, and a plurality of spaced stabilization walls for stabilizing the spaced side walls upon application of the applied impact force. The spaced side walls are substantially perpendicular to the spaced load distribution walls, and the spaced stabilization walls are substantially parallel to the spaced load distribution walls. The plurality of spaced side walls connect, respectively, the plurality of spaced load distribution walls and the plurality of spaced stabilization walls to form the accordion-shaped portion of the energy absorbing cartridge.

In one embodiment, at least some of the spaced side walls are configured in a length sufficient to result in an applied impact force being applied by a first feature of an object and at least some of the spaced side walls are configured in a length sufficient to result in the applied impact force being applied by a second feature of the object.

In yet another embodiment, the energy absorbing cartridge of the present invention is provided in combination with a vehicle.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a fragmentary schematic perspective illustration of an energy absorbing cartridge of the present invention mounted between a “B” pillar trim module and a substantially rigid support “B” pillar of a vehicle;

FIG. 2 is a schematic perspective illustration of the energy absorbing cartridge;

FIG. 3 is a schematic side cross-sectional illustration of the plurality of spaced load distribution walls, the plurality of spaced side walls, and the plurality of spaced stabilization walls in the accordion-shaped portion of the energy absorbing cartridge;

FIG. 4 is a schematic side cross-sectional illustration of the plurality of spaced load distribution walls, the plurality of spaced side walls, and the plurality of spaced stabilization walls in the accordion-shaped portion of the energy absorbing cartridge of the present invention at an initial stage of deformation during an impact event;

FIG. 5 is a schematic side cross-sectional illustration of the plurality of spaced load distribution walls, the plurality of spaced side walls, and the plurality of spaced stabilization walls in the accordion-shaped portion of the energy absorbing cartridge of the present invention at an intermediate stage of deformation during an impact event;

FIG. 6 is a schematic side cross-sectional illustration of the plurality of spaced load distribution walls, the plurality of spaced side walls, and the plurality of spaced stabilization walls in the accordion-shaped portion of the energy absorbing cartridge of the present invention at a later stage of deformation during an impact event; and

FIG. 7 is a graph of acceleration (G) versus time (milliseconds) as an object impacts the energy absorbing cartridge during an impact event.

### DETAILED DESCRIPTION

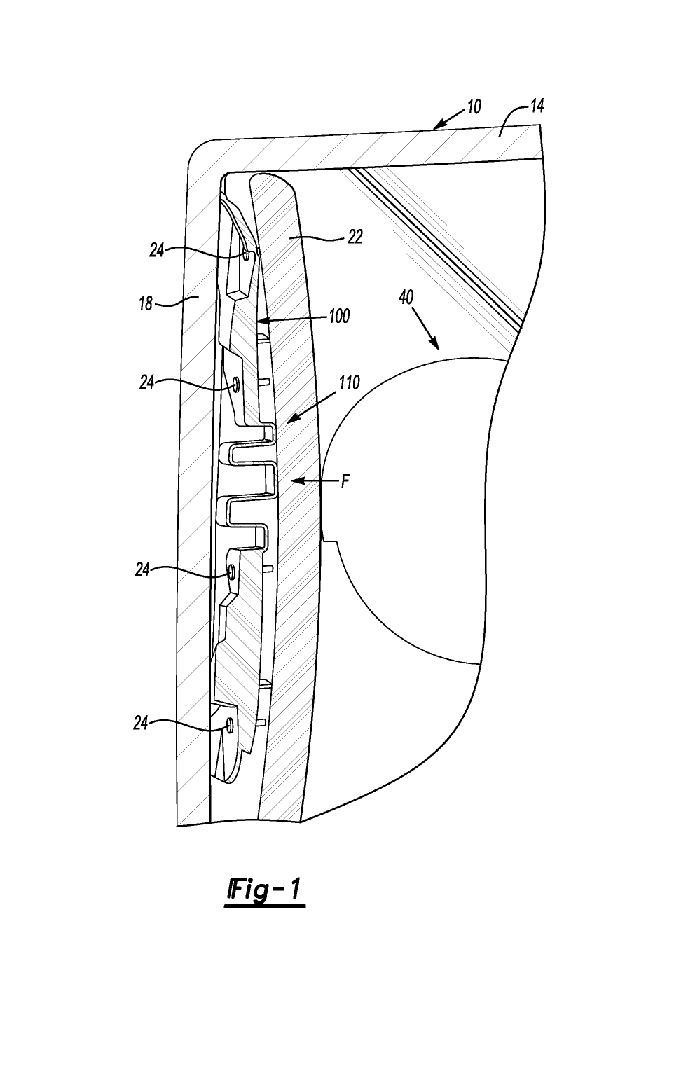

Referring to the drawings, wherein like numbers refer to like components throughout the several views, FIG. 1 shows a fragment of a vehicle 10 having a roof 14 connected to a substantially rigid vehicle support pillar 18 such as a “B” pillar, formed of structural steel or other known structural material. Covering the substantially rigid vehicle support pillar 18 is an interior trim module 22 and an energy absorbing cartridge 100 of the present invention. The energy absorbing cartridge 100 has an accordion-shaped portion 110. The energy absorbing cartridge 100 is mounted in the vehicle 10 by typical fasteners 24 so that the accordion-shaped portion 110 may receive an impact force F from an object 40.

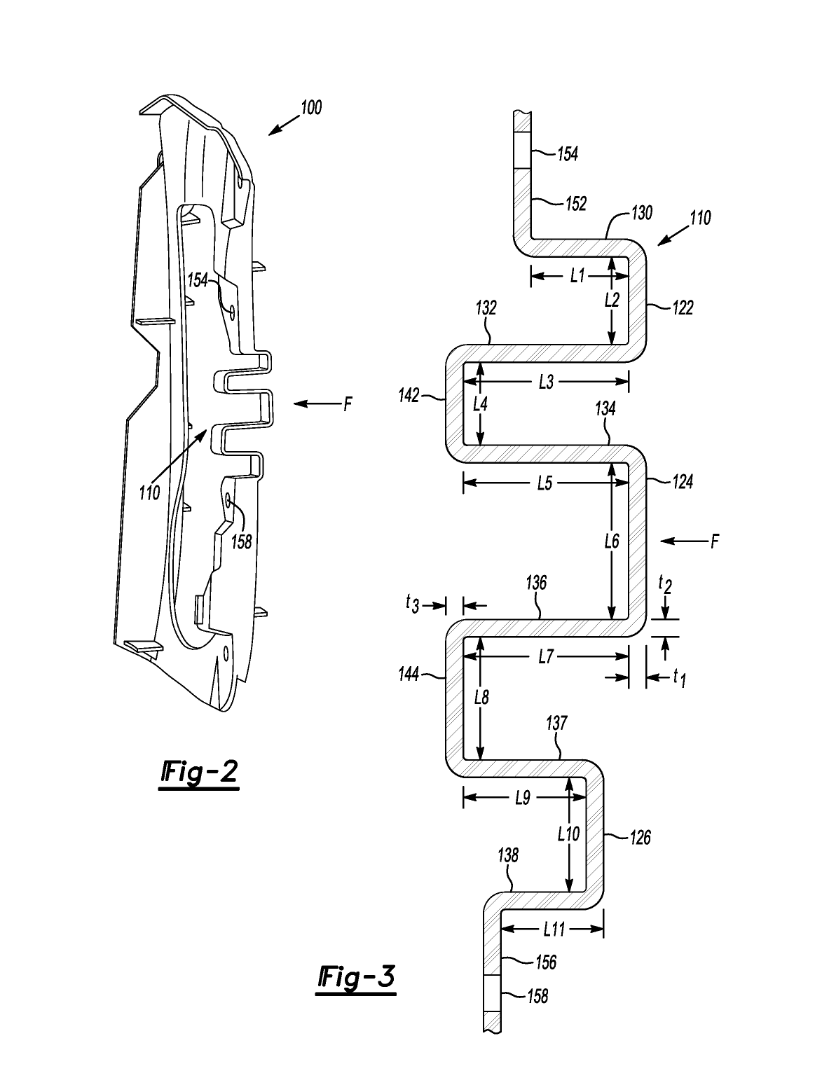

In FIG. 2, the energy absorbing cartridge 100 is shown separately in perspective view. The energy absorbing cartridge 100 having the accordion-shaped portion 110 may be molded using a deformable thermoplastic material including a thermoplastic olefin such as a polyolefin alloy—talc filled. The polyolefin alloy may be an alloy of polypropylene plastic and ethylene propylene or ethylene propylene diene monomer rubber. Other similar energy absorbing materials may be used as long as the material has a relatively high stiffness to impact force and can perform over a standard vehicle interior temperature range without becoming brittle. Additionally other methods of forming the energy absorbing cartridge 100, besides the molding process listed above, may be used within the scope of the present invention.

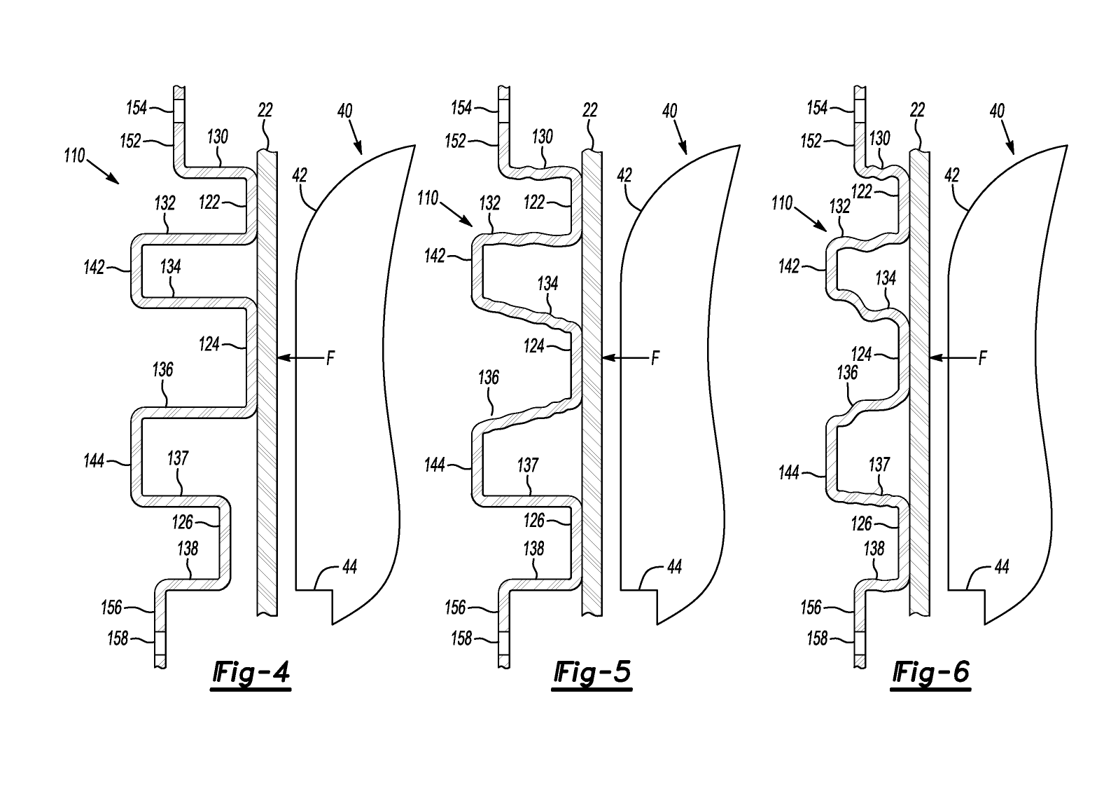

Referring to FIG. 3, a cross-sectional side view of the accordion-shaped portion 110 is shown. The accordion-shaped portion 110 has a series of substantially square waveforms formed in part by spaced load distribution walls 122, 124, 126. Some of the spaced side walls 132, 134, 136, 137 connect the spaced load distribution walls 122, 124, 126 respectively to the spaced stabilization walls 142, 144 to form the accordion-shaped portion 110. The spaced side walls 130, 132, 134, 136, 137, 138 are substantially perpendicular to the spaced load distribution walls before deformation. The spaced stabilization walls 142, 144 are substantially parallel to the spaced load distribution walls 122, 124, 126. Thus, throughout this specification, the term accordion-shaped portion 110 encompasses the series of substantially square waveforms which are formed by the spaced load distribution walls 122, 124, 126; the spaced side walls 130, 132, 134, 136, 137, 138; and the spaced stabilization walls 142, 144; along with the attachment members 152 and 156. For example, one such substantially square waveform may include spaced load distribution wall 122, spaced side wall 132 and spaced stabilization wall 142 while another substantially square waveform may include spaced load distribution wall 124, spaced side wall 136 and spaced stabilization wall 144. As described hereinbelow with reference to FIGS. 4, 5 and 6, the spaced load distribution walls 122, 124, 126 are configured to deform by bending so as to distribute and transfer the applied impact force F in a controlled curving manner (impermanently). The spaced side walls 130, 132, 134, 136, 137, 138 are configured to deform by buckling upon application of the applied impact force F which results in the spaced side walls 130, 132, 134, 136, 137, 138 crumpling and collapsing (permanently). The spaced stabilization walls 142, 144 stabilize the spaced side walls 132, 134, 136, 137 upon application of the applied impact force F.

Referring again to FIG. 3, the spaced side walls 130 and 138 respectively connect to attachment members 152 and 156 respectively which include attachment devices such as apertures 154 and 158 respectively. The spaced load distribution wall 124 has a thickness t1, the spaced side wall 136 has a thickness t2, and the spaced stabilization wall 144 has a thickness t3, and the thicknesses t1, t2, and t3 may be substantially equal. Although not specifically designated, it is to be understood that each of the other spaced load distribution walls, spaced side walls and spaced stabilization walls may have a thickness which is substantially equal. Actual dimensions for the accordion-shaped portion are dependent on the installation, material used and other design criteria. In one example, the accordion-shaped portion includes square waveforms that may have a substantially equivalent thickness t1=t2=t3=2.5 mm (millimeters). In another example, the spaced side wall 130 may have a length L1=12.4 mm. In still others, the spaced load distribution wall 122 may have a length L2=7.5 mm, the spaced side wall 132 may have a length L3=22 mm, the spaced stabilization wall 142 may have a length L4=7.5 mm, the spaced side wall 134 may have a length L5=22 mm, the spaced load distribution wall 124 may have a length L6=15.3 mm, the spaced side wall 136 may have a length L7=23.7 mm, the spaced stabilization wall 144 may have a length L8=11.7 mm, the spaced side wall 137 may have a length L9=18 mm, the spaced load distribution wall 126 may have a length L10=10.9 mm, and the spaced side wall 138 may have a length L11=10.6 mm. The preceding length dimensions were measured tangent to tangent and are provided for illustrative purposes, not as a limitation of the present invention.

As shown in FIGS. 2 and 3, an impact force F is applicable to the accordion-shaped portion 110 of the energy absorbing cartridge 100 during an impact event. Also shown in FIGS. 2 and 3 are attachment devices shown as apertures 154 and 158 respectively which enable standard interior trim fasteners to affix the energy absorbing cartridge 100 to the interior trim module 22 (as shown in FIG. 1). These attachment devices 154 and 158 insure that the accordion-shaped portion 110 maintains its position as an impact force F is applied to it. Referring to FIG. 1, if the energy absorbing cartridge 100 is not securely attached to the interior trim module 22, the accordion-shaped portion 110 may undesirably shift and not perform optimally during an impact event.

In FIGS. 4, 5 and 6, schematic side view illustrations of the accordion-shaped portion 110 of the energy absorbing cartridge 100 of FIGS. 1 and 2 at an initial, intermediate and later stage of deformation, respectively, during an impact event are shown. In each of the FIGS. 4, 5 and 6, an object 40 is shown including a first feature 42 and a second feature 44 which are designated for describing aspects of the present invention. For clarity, the interior trim module 22 of FIG. 1 is schematically shown as a substantially firm rectangle shape in FIGS. 4, 5 and 6 through which the impact force F from the object 40 is transferred to the accordion-shaped portion 110 of the energy absorbing cartridge 100 of the present invention.

Referring first to FIG. 4, an impact event is shown when the object's first feature 42 impacts the interior trim module 22 so that the impact force F is applied to the spaced load distribution walls 122 and 124 by the object's first feature 42. The spaced load distribution walls 122 and 124 are configured to deform by bending slightly while distributing and transferring the impact force F. Thus, no deformation by buckling of the spaced side walls 130, 132, 134, 136, 137, 138 occurs at this point in time. At least some of the spaced side walls 130, 132,134,136 are configured in a length sufficient to result in the applied impact force F being applied by the object's first feature 42 to the load distribution walls 122 and 124. Since the spaced load distribution wall 126 is connected by the spaced side walls 137 and 138 which are configured in a length which is not sufficient to result in the applied impact force F being applied by the object's first feature 42, there is no impact force F applied to the spaced load distribution wall 126.

Next referring to FIG. 5, the impact event continues so that the impact force F is applied to the spaced load distribution walls 122, 124 which are configured to deform by bending while distributing and transferring the impact force F to the spaced side walls 130, 132, 134, 136 which are configured to deform by buckling to absorb the impact energy. The spaced stabilization walls 142, 144 insure that the spaced side walls 132, 134 and 136 deform by buckling in a controlled manner. The configured length of each of the spaced side walls 137 and 138 are sufficient to result in the applied impact force F being subsequently applied by the object's second feature 44, to the spaced load distribution wall 126 as the impact force F continues to be applied to the spaced load distribution walls 122 and 124 as described above. The spaced load distribution wall 126 is configured to deform by bending slightly while distributing and transferring the impact force F, but no deformation by buckling of the spaced side walls 137 and 138 occurs at this point in time.

Next referring to FIG. 6, the impact event continues so that the impact force F is applied to the spaced load distribution walls 122, 124, 126 which are configured to deform by bending while distributing and transferring the impact force F to the spaced side walls 130, 132, 134, 136, 137 and 138 which are configured to deform by buckling to absorb the impact energy. The spaced stabilization walls 142, 144 insure that the spaced side walls 132, 134, 136, 137 deform by buckling in a controlled manner.

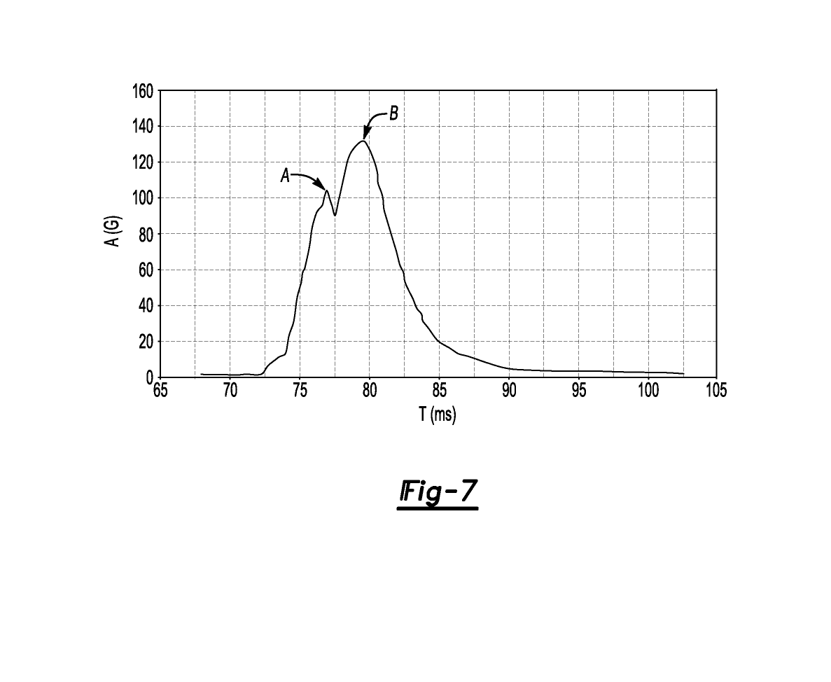

Referring to FIG. 7, a graph of acceleration (G) versus time (milliseconds) as an impact force is applied to the energy absorbing cartridge during an impact event is shown. The graph has two peaks (labeled A and B) indicating the acceleration when the object's first feature 42 (shown in FIGS. 4, 5 and 6) impacts the accordion-shaped portion 110 (peak A) and the acceleration when the object's second feature 44 (shown in FIGS. 4, 5 and 6) impacts the accordion-shaped portion 110 (peak B), of the energy absorbing cartridge 100 of the present invention.

It is understood that the embodiments shown in detail in the drawings and described above are for illustration and designs having various numbers, lengths and other characteristics of spaced load distribution walls, spaced side walls and spaced stabilization walls are within the scope of the present invention.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An energy absorbing cartridge for covering a substantially rigid vehicle support pillar, the energy absorbing cartridge comprising:
a plurality of spaced load distribution walls for distributing and transferring an applied impact force;
a plurality of spaced side walls for absorbing the applied impact force, wherein each of the plurality of spaced side walls is perpendicular to each of the plurality of spaced load distribution walls; and
a plurality of spaced stabilization walls for stabilizing the spaced side walls upon application of the applied impact force, wherein each of the plurality of spaced stabilization walls is parallel to each of the plurality of spaced load distribution walls;
wherein the plurality of spaced side walls connects, respectively, the plurality of spaced load distribution walls and the plurality of spaced stabilization walls to form an accordion-shaped portion.

2. The energy absorbing cartridge of claim 1, wherein the accordion-shaped portion includes a series of square waveforms formed by the plurality of spaced load distribution walls, the plurality of spaced side walls and the plurality of spaced stabilization walls.

3. The energy absorbing cartridge of claim 1, wherein the plurality of spaced load distribution walls are configured to deform by bending upon application of the applied impact force.

4. The energy absorbing cartridge of claim 1, wherein the plurality of spaced side walls is configured to deform by buckling upon application of the applied impact force.

5. The energy absorbing cartridge of claim 1, wherein the plurality of spaced load distribution walls, the plurality of spaced side walls, and the plurality of spaced stabilization walls each have a thickness which is substantially equal.

6. The energy absorbing cartridge of claim 1, wherein at least some of the plurality spaced side walls are configured in a length sufficient to result in the applied impact force being applied by a first feature of an object.

7. The energy absorbing cartridge of claim 6, wherein at least some of the other of the plurality of spaced side walls are configured in a length insufficient to result in the applied impact force being applied initially by a second feature of the object, but sufficient to result in the applied impact force being applied subsequently by the second feature of the object as the impact force continues to be applied.

8. The energy absorbing cartridge of claim 1, wherein the accordion-shaped portion is formed of a deformable thermoplastic material.

9. A vehicle comprising:
a roof;
a substantially rigid vehicle support pillar connected to the roof;
an interior trim module attached to the substantially rigid vehicle support pillar; and
an energy absorbing cartridge covering the substantially rigid vehicle support pillar, the energy absorbing cartridge including:
a plurality of spaced load distribution walls for distributing and transferring an applied impact force;
a plurality of spaced side walls for absorbing the applied impact force, wherein each of the plurality of spaced side walls is perpendicular to each of the plurality of spaced load distribution walls; and
a plurality of spaced stabilization walls for stabilizing the spaced side walls upon application of the applied impact force, wherein each of the plurality of spaced stabilization walls is parallel to each of the plurality of spaced load distribution walls;
wherein the plurality of spaced side walls connects, respectively, the plurality of spaced load distribution walls and the plurality of spaced stabilization walls to form an accordion-shaped portion.

10. The vehicle of claim 9, wherein the accordion-shaped portion includes a series of square waveforms formed by the plurality of spaced load distribution walls, the plurality of spaced side walls and the plurality of spaced stabilization walls.

11. The vehicle of claim 9, wherein the substantially rigid vehicle support pillar is a “B” pillar.

12. The vehicle of claim 9, wherein the accordion-shaped portion of the energy absorbing cartridge is attached to the interior trim module by an attachment member connected to at least one of the plurality of spaced side walls.

13. The vehicle of claim 9, wherein the plurality of spaced load distribution walls are configured to deform by bending upon application of the applied impact force.

14. The vehicle of claim 9, wherein the plurality of spaced side walls is configured to deform by buckling upon application of the applied impact force.

15. The vehicle of claim 9, wherein the plurality of spaced load distribution walls, the plurality of spaced side walls, and the plurality of spaced stabilization walls each have a thickness which is substantially equal.

16. The vehicle of claim 9, wherein at least some of the plurality of spaced side walls are configured in a length sufficient to result in the applied impact force being applied by a first feature of an object.

17. The vehicle of claim 16, wherein at least some of the other of the plurality of spaced side walls are configured in a length insufficient to result in an the applied impact force being applied initially by a second feature of the object, but sufficient to result in the applied impact force being applied subsequently by the second feature of the object as the impact force continues to be applied.

18. The vehicle of claim 9, wherein the energy absorbing cartridge is formed of a deformable thermoplastic material.

19. The energy absorbing cartridge of claim 7, wherein, as the impact force continues to be applied, the plurality of spaced load distribution walls distributes and transfers the impact force to each of the plurality of spaced side walls.

20. The vehicle of claim 17, wherein, as the impact force continues to be applied, the plurality of spaced load distribution walls distributes and transfers the impact force to each of the plurality of spaced side walls.
